(19) United States
(12) Patent Application Publication
(10) Pub. No.: US 2024/0211902 A1
(43) Pub. Date: Jun. 27, 2024

(54) THIN NETWORK TRANSACTION INTEGRATION SERVICES

(71) Applicant: NCR Voyix Corporation, Atlanta, GA (US)

(72) Inventor: Robert Michael Dolezal, Buford, GA (US)

(21) Appl. No.: 18/087,019

(22) Filed: Dec. 22, 2022

(51) Int. Cl. G06Q 20/10; G06Q 20/38

(52) U.S. Cl. CPC G06Q 20/10; G06Q 20/3829; G06Q 20/385; G06Q 2220/00

(57) ABSTRACT

Transaction integration services are provided that receive transaction data for transactions from one or more parties to the transactions in a variety of data formats. The services process customizable workflows based on the parties, enhance security of the transactions, and extend capabilities to the transactions beyond that which is available through legacy transaction services. The services integrate portions of received transaction data with the existing and legacy transaction services using legacy interfaces to complete the transactions on legacy resources associated with the transactions. The enhanced security and extended capabilities for the transactions are seamlessly and transparently processed without requiring any modifications to source code and existing transaction workflows associated with the legacy transaction services.

### BACKGROUND

Often innovation is hindered by the underlying data model for a resource. For example, financial accounts are based on a historical model that includes a financial institution's routing number and a customer's corresponding account number. The model has remained stagnant and yet financial institutions have based their operations, infrastructure, and customer services on this model. As a result, accounts are immutable resources with a set of largely universal rules that govern access.

Further, consumer and business services, which are provided for accessing the data models, are relegated into workflows and features which are constrained by the universal rules and the infrastructure. Commonly practiced and understood workflows make it easier for thieves to develop technology and devices which circumvent existing security practices and technologies.

Consumers and businesses may be eager to adopt innovations, but the rate of adoption is gated by the resource custodians and their data models. The chief impediments to adoption are (1) the need for overhauling legacy account infrastructures to support innovations, and (2) the likely uneven pace of adoption of the innovations, because some features are most powerful when broadly supported by various stakeholders—resource custodians, consumer and business services, etc. —to implement the innovations.

Thus, changes to the data models would require service providers to update their workflows and infrastructures. The enormity of time and expense associated with updating legacy workflows and infrastructures has hindered any substantial enhancements to the consumer and business services within the transaction industry.

### SUMMARY

In various embodiments, methods and a system for thin network transaction integration services are presented. Consumer, organization, and business front-end interfaces are provided to user-operated devices for performing transactions using cloud-based/server-based transaction services. Each transaction service associated with a different workflow and each workflow can be dynamically customized based on one or more parties to a given transaction. Transaction data is received for a given transaction from one or more consumers, businesses, and/or organizations through the front-end interfaces. A specific service is assigned to process the given transaction utilizing that service's workflow. Selective transaction data and/or output from the specific service is provided to one or more legacy transaction services and/or legacy account services utilizing a legacy interface of the legacy transaction service(s) and/or legacy account service(s). The legacy transaction service and/or legacy account service performs operations on one or more legacy resources associated with the transaction to complete the transaction on behalf of the one or more parties. The services provide enhanced features, function, and security to the transactions by leveraging the legacy transaction services and/or legacy account services through their existing interfaces and without modifying any source code or any legacy workflows associated with the legacy transaction services and/or legacy account services.

### BRIEF DESCRIPTION OF THE DRAWINGS

FIG. 1A is a diagram depicting features of thin network transaction integration service, according to an example embodiment.

FIG. 1B is a diagram of a system for providing thin network transaction integration services, according to an example embodiment.

FIG. 2A is a flow diagram of a method for providing and operating thin network transaction integration services, according to an example embodiment.

FIG. 2B is a flow diagram of example embodiments of the method of FIG. 2A.

FIG. 2C is a flow diagram of additional example embodiments of the method of FIG. 2A.

FIG. 3 is a flow diagram of another method for providing and operating thin network transaction integration services, according to an example embodiment.

### DETAILED DESCRIPTION

Because legacy data models for legacy transactions drive technological improvements provided via legacy transaction services, there has been little innovation in the industry with respect to some types of transactions. As a result, legacy transaction services constrain what innovations can be achieved. The impediments to rapid technology adoption by legacy transaction services are mitigated herein and below by leaving the legacy transaction services unchanged and unmodified. Thin network transaction integration services are provided to process a variety of enhanced operations for transactions utilizing customized workflows and integrating on the back end with legacy transaction services.

Front-end interfaces are provided to consumers, organizations, and businesses for purposes of providing new and novel transaction workflows for transactions. The front-end interfaces provide transaction data input (received from parties) to the transaction integration services for transactions. The services implement enhanced features and functions by processing their workflows and the transactions are completed by integrating selective output/transaction data from the services into the existing legacy workflows of existing legacy transaction services. It is to be noted that the existing legacy workflows and existing legacy transaction services require no software changes and can be integrated through their existing Application Programming Interfaces (APIs). In this way, processing of the transaction integration services is completely transparent to the existing legacy transaction services.

As used herein a “resource” is a data asset associated with a given party to a transaction and represented in a data model. For example, a resource may be a financial account, social media account, or other service-based account. A “service” is a one or more sets of cooperating executable instructions that perform access operations between two or more parties using one or more resources. A “legacy resource” is an existing data model for which access is obtained through a “legacy resource service.” For example, a legacy resource many be a bank account for which access is controlled through legacy APIs and/or legacy interfaces (e.g., legacy resource services) associated with a resource union (e.g., credit union).

The terms “consumer,” “shopper,” and/or “customer” can be used interchangeably and synonymously herein. This is an individual performing a financial transaction with a business or organization. The terms “party” and/or “user” may be used interchangeably and synonymously herein. This is an individual (consumer, organization, merchant, or business individual) engaged in a transaction with at least one other individual.

A “transaction” is a set of operations processed during which access is requested to one or more resources. For example, a transaction can include funds transferred from a customer bank account to a business bank account for goods or services being purchased by the customer from the business; a transfer of funds from a first bank account of a first user to a second bank account of a second user; a first user requesting information from a service account or social media account of a second user; etc. In this way a transaction can be directed to a financial transaction, a social media transaction, and/or a service-based transaction.

An “resource owner” is an individual or an entity (e.g., business) that controls at least one legacy resource. An owner can be any entity such as a consumer, a business, a government agency, and/or a non-profit organization.

As used herein the phrase “legacy service” refers to any existing service available whether the existing service provides new or old modes of operation. That is, a legacy service should not be mistaken for an outdated service since it can be a modern and new service. Essentially, a legacy service is an existing available service in the transaction industry and whether it is considered modern or dated is irrelevant.

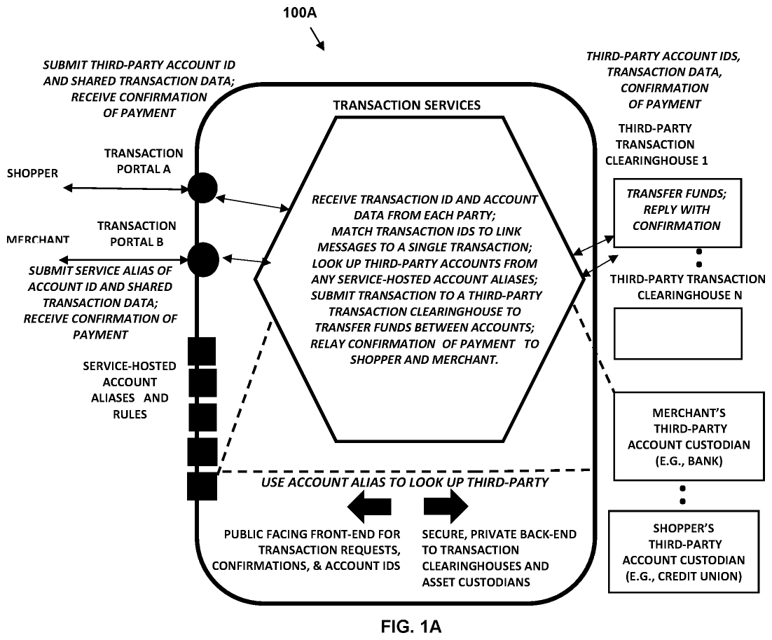

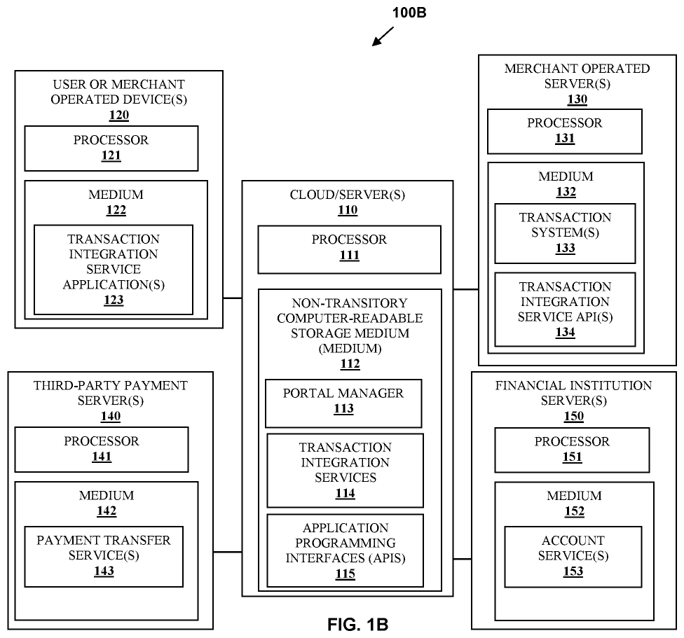

FIG. 1A is a diagram 100A depicting capabilities of thin network-based integration services (shown as transaction integration services 113 shown in FIG. 1B discussed below), according to an example embodiment. Transaction integration services 114 are depicted in FIG. 1A as “Transaction Services.” The services 114 provide front-end interfaces to users (e.g., identified as shopper and merchant in FIG. 1A). The front-end interfaces can be applications with user interfaces provided to mobile and/or standalone devices operated by the users or provided through web pages of browsers of the mobile and/or standalone devices. The front-end interfaces can also be provided as APIs to merchant-based applications executed on merchant-operated devices.

Transaction data is received from one or more parties engaged in transactions through the front-end interfaces. The transaction data for a given transaction can be received from a single party to the transaction or separately from two or more parties to the transaction. When two or more parties provide subsets of the transaction data as a whole, the separately provided subsets of transaction data can include overlapping or repeated portions of the transaction data, such as a transaction identifier for the transaction, a total transaction cost (when applicable), a store merchant identifier, a location identifier, etc.

Moreover, the transaction data or subsets of transaction data can be provided through the front-end interfaces by the parties to the services 114 in a variety of encrypted formats. Each party can encrypt any provided transaction data using a key that is unique to that party. For example, a first party can encrypt a first subset of the transaction data using a first key that is unique to the first party and provide a first encrypted subset of transaction data to services 114 while a second party can encrypt a second subset of the transaction data using a second key that is unique to the second party and provide a second encrypted subset of transaction data to services 114.

Furthermore, some portions of transaction data provided by a party to a transaction can be encrypted while other portions of the same transaction data provided by the same party remain unencrypted or in readable text format. In some embodiments, none of the transaction data provided by a party to a transaction is encrypted (i.e., all of a given party's transaction data is in readable text format).

Each of the services 114 is associated with a specific type of transaction. The front-end interfaces can identify the type of transaction from selections made by the parties to a given transaction. The type of transaction is then forwarded to a portal or a website of cloud/server 110 (discussed below and shown in FIG. 1B). Transaction data provided by the parties to a specific portal of cloud/server 110 activates a specific service 114. The activated service 114 is associated with a given workflow that is processed for the transaction. The workflow can include custom rules based on one or more parties to the transaction. The custom rules when processed dynamically alter the workflow based on customizations associated with one or more of the parties. For example, one party to a transaction can include a custom rule to index and store transaction data associated with the party in a cloud/server 110 data store or in a third-party data store. As another example, one party to a transaction can provide all or portions of transaction data for a transaction in an encrypted format while another party to the transaction provides portions of the transaction data in a text readable format. It is noted that there is a plethora of customizations than can be performed on any base workflow by a given service 114 based on custom rules set on identifiers for the parties.

FIG. 1A illustrates some example services 114 and example transaction types processed by the services 114 where the corresponding transactions are integrated by the services 114 into legacy workflows associated with legacy transaction services (identified in FIG. 1A as “third-party transaction clearinghouses,” “merchant third-party account custodians (e.g., banks)”, and “shopper third-party account custodians (e.g., credit unions)”). Services 114 utilize legacy APIs associated with the legacy transaction services to provide selective transaction data for any given transaction to the legacy services causing the legacy services to access legacy resources associated with the transaction and completing the transaction. For example, a service 114 can provide a legacy account associated with a given shopper, a transaction amount for a given transaction, and a merchant legacy account for a merchant associated with the transaction to a legacy third-party transaction clearing house via a legacy API used by the clearing house. This causes the clearing house to transfer the transaction amount from the shopper's legacy account to the merchant's legacy account and send a confirmation back to service 114 through the legacy API once completed. Once confirmation is received, service 114 can send confirmations of completion back to the shopper and the merchant. It is to be noted that this example is different from traditional purchase transactions where it is just the merchant who receives confirmation back from the legacy clearinghouse and the shopper has to rely on confirmation from the merchant.

In an embodiment, cloud/server 114 can also manage virtualized resources for the parties. The virtualized resources are mapped to legacy resources managed by legacy banks and/or legacy credit unions. Services 114 can identify aliased or virtualized resources via the account identifiers provided through the front-end interfaces by the parties, map the aliases to the legacy resources, and utilize a legacy API associated with the corresponding legacy bank/credit union to directly access the legacy resources of the parties to a transaction. Ledgers maintained by cloud/server 114 maintain proper balances following transactions performed by the parties with the corresponding parties' legacy accounts maintained by the legacy banks/credit unions. Services 114 can enforce any virtual resource rules set on an aliased account during a given transaction. For example, an aliased account can be associated with rules for deposit of funds only and not withdrawals, such that a transaction attempting a withdrawal from the aliased account is denied by the services 114. In an embodiment, the virtual resources/aliased accounts can be defined based on pools of funds, purpose of a party, functionality desired by the party, and/or custom capability desired by a party. For example, a party can have an alias account associated with Euros and another associated with U.S. dollars, funds into and out of an alias account pool correspond to the type of assets associated with the pools. Thus, to save currency-conversion fees, rules would prevent U.S. dollars from being deposited into an alias account denominated in Euros and prevent U.S. dollars from being withdrawn from a Euro-denominated alias account. It is noted that a plethora of customizations and rules on the aliased accounts can be achieved and the above provided example was presented for purposes of illustration only. Essentially, custom resources are overlaid on legacy resources via customizations by the parties and rules associated with each virtualized resource can be enforced during transactions by services 114. Services 114 also interact with the legacy banks/credit unions to complete any transaction that changes a legacy account based on usage of an alias account using a legacy API to cause the changes to be performed by the legacy bank/credit union.

Services 114 utilize secure private backend communications when interacting with the legacy transaction services. For example, encrypted protocols are used between services and legacy transaction services, encrypted data is provided by services 114 to the legacy transactions services, and/or private closed networks are used by services 114 when communicating with the legacy transaction services.

Conversely, services 114 utilize public-facing front-end interfaces and networks to interact with the devices operated by the parties. The communications between services 114 and the parties can be made secure through the encryption approaches discussed above.

In an embodiment, a first party to a transaction provides an encrypted legacy resource identifier associated with a legacy resource to a second party to the transaction. The second party assembles the transaction data for the transaction with the encrypted resource identifier and provides all the transaction data for the transaction to a given service 114 for processing. The second party is unable to decrypt the encrypted resource identifier. In an embodiment, rather than providing encrypted resource information the first party sends a non-encrypted or text readable aliased resource identifier, the second party assembles the transaction data with the aliased resource identifier and provides all the transaction data to the service for processing. In an embodiment, the first party encrypts a contact identifier for the first party and provides to the second party with either an encrypted legacy resource identifier or a non-encrypted/text readable aliased resource identifier. The second party provides what the first party provided along with additional transaction data to the service 114, and the service 114 decrypts the encrypted information to identify the contact identifier for the first party, which is used by the service 114 to send a confirmation back to the first party when a corresponding legacy transaction service confirms that the transaction completed against the legacy resource. The contact identifier can be an email address, a text number, or website where the confirmation is sent or posted on behalf of the first party. In an embodiment, the first party is a payer, and the second party is a payee in the transaction. In an embodiment, the first party is a payee, and the second party is the payer in the transaction.

In an embodiment, two or more parties to a transaction each submit separate transaction data to a given service 114. The service 114 matches the subsets of transaction data provided by the parties based on each subset being associated with a common transaction identifier for the transaction. In this way, the parties need not exchange any information between them for purposes of processing the transaction as the subsets are merged and managed as a single transaction by service 114.

FIG. 1B is a diagram of a system 100B for providing thin network transaction integration services, according to an example embodiment. It is to be noted that the components are shown schematically in greatly simplified form, with only those components relevant to understanding of the embodiments being illustrated. Furthermore, the various components depicted in FIG. 1B and their arrangement is illustrative and not exhaustive. It is to be noted that other arrangements with more or fewer components are possible without departing from the teachings of providing and operating thin network transaction integration services according to embodiments of the disclosed technology.

System 100B includes at least one cloud/server 110, user or merchant-operated devices 120, merchant-operated servers 130, third-party payment servers 140, and financial institution (FI) servers 150. Cloud/server 110 includes at least one processor 111 and a non-transitory computer-readable storage medium 112. Medium 112 includes a portal manager 113, transaction integration services 114, and APIs 115, each of which includes executable instructions, that when executed by processor 111, cause processor 111 to perform corresponding operations discussed herein and below with respect to 113-115.

Each user or merchant-operated device 120 (hereinafter “party-operated device 120”) includes at least one processor 121 and a non-transitory computer-readable storage medium 122. Medium 122 includes a one or more transaction integration service applications 123 that include executable instructions which, when executed by processor 121, cause processor 121 to perform corresponding operations discussed herein and below with respect to 123.

Each merchant-operated server 130 includes at least one processor 131 and a non-transitory computer-readable storage medium 132. Medium 132 includes a transaction system 133 and transaction integration service APIs 134, each of which includes executable instructions that, when executed by processor 131, cause processor 131 to perform corresponding operations discussed herein and below with respect to 133 and 134.

Each third-party payment server 140 includes at least one processor 141 and a non-transitory computer-readable storage medium 142. Medium 142 includes a payment transfer service 143, which includes executable instructions that, when executed by processor 141, cause processor 141 to perform corresponding operations discussed herein and below with respect to 143.

Each FI server 150 includes at least one processor 151 and a non-transitory computer-readable storage medium 152. Medium 152 includes an account service 153, which includes executable instructions that, when executed by processor 151, cause processor 151 to perform corresponding operations discussed herein and below with respect to 153.

Initially, the parties can include registered users of the virtualized resources (i.e., aliased resources) provided through cloud 110 as discussed above. However, the parties do not have to be registered users of the virtualized resources such that one or more parties to a given transaction can include any combination of registered users and/or non-registered users. A non-registered user is a party to a transaction that utilizes just legacy resources for a given transaction.

In an embodiment, portal manager 113 assigns services 114 to a corresponding website or communication port of cloud 110 for monitoring of transactions being received through front-end interfaces of transaction integration service applications 123 and received through transaction integration service APIs 134. Each service 114 is assigned a website or communication portal based on a type of transaction and a workflow that the corresponding service 114 processes for its transactions. As was stated above, the assigned workflows are not static but are rather more of a template or a baseline workflow that can be dynamically altered based on customized rules associated with a given party to a transaction. The transaction integration service applications 123 and the transaction integration service APIs can send a given transaction directly to the website or communication portal monitored by the corresponding assigned service 114 based on the corresponding transaction type. Alternatively, portal manger 113 monitors transaction data received over a single communication portal or website of cloud 110, determines the transaction type, and routes the transaction data to the corresponding service 114 based on the transaction type.

When a service 114 receives transaction data, its assigned workflow is processed by the service 114. Any transaction data for a transaction not received entirely from a single party to the transaction is associated and combined with other subsets transaction data received from other parties to the transaction based on a unique transaction identifier or unique token associated with each of the subsets of transaction data. Service 114 utilizes party identifiers for the parties or device identifiers for devices operated by the parties to obtain any customized rules associated with the parties. This causes service 114 to customize its workflow with the customized party rules. For example, service 114 can decrypt any transaction data based on the parties to the transaction for purposes of obtaining decrypted legacy resource identifiers, decrypted party contact identifiers, and/or decrypted transaction data as a whole when the transaction data is entirely encrypted.

Each service 114 can also identify any portion of the transaction data associated with an aliased resource and obtain additional rules associated with the aliased resource and identify a legacy resource identifier mapped to the aliased resource. The original workflow or the customized workflow is processed by the service 114.

Each service 114 obtains selective portions of the transaction data augmented with any legacy resources that were mapped to any aliased resource and processes API 115 to send modified transaction data for the transaction to a corresponding payment transfer service 143 or an account service 153. This causes payment transfer service 143 or account service 153 to perform operations against legacy resources of the parties to complete the transaction on behalf of the parties. Payment transfer service 143 or account service 153 sends back a confirmation when the operations are complete. Service 114 sends the confirmation to the parties via transaction integration service applications 123 and/or transaction integration service APIs 134. In an embodiment, rules associated with the parties cause service 114 to send the confirmation to one or more specific contact addresses associated with the parties, such as an email address, a text message number, or a website where the confirmation is posted.

System 100B links transaction data provided through front-end interfaces of transaction integration service applications 123 and transaction integration service APIs to specific transaction integration services 114 based on transaction types for transactions. The services 114 enhance security and features/functions for the transactions beyond what is available through legacy payment transfer services 143 and account services 143. In an embodiment, cloud 110 and services 114 also enhance security and features/functions for legacy resources through management of virtualized resources beyond what is available for the legacy resources that are managed by legacy account services 153. Services 114 also fully and seamlessly integrate with existing and legacy payment transfer services 143 and account services 153 by supplying selective transaction data for the transactions to services 143 and 153 through API 115. No modifications to the source code of services 143 and 153 are needed to achieve integration.

In an embodiment, a specialized service 114 is provided to maintain transaction details for transaction and other rich transaction data including receipts, invoices, rebates, warranties, promotions, coupons, usage instructions, medical data from doctor visits, etc. The specialized service 114 provides interfaces for historical transaction data mining, transaction archiving, transaction searching, etc.

In an embodiment, the legacy resource can include accounts of an individual associated with personal medical data, frequent-flyer miles, shopper reward points, digital coupons, social media data, gaming data, etc. In this way, the legacy resources and the legacy resource services can include more than financial accounts, and more than payment networks as was described above.

In an embodiment, an account alias or aliased account can access any of several legacy services or accounts through the legacy services based on user-defined factors. For example, the factors can include the currency type, which is linked to a specific legacy service and corresponding account associated with the legacy service; e.g., one account for U.S. dollars, another account for Euros, etc. In fact, other factors of a transaction can be used to resolve the legacy services and corresponding accounts for a given user. In an embodiment, a thin transaction integration service 114, may, for a given transaction that requires no novel processing, operate as a simple pass-through to a legacy transaction service 143 or a legacy account service 153. The selection of the legacy service 143/153 may be determined automatically or may depend on details of a transaction, such as the form of payment or the amount of funds to be transferred.

In an embodiment, a legacy account custodian (e.g., bank or credit union) can also send confirmation of transaction success or failure to the account holder, instead of having just the service(s) 114 send the account holder confirmation of success/failure. So, an account holder can receive confirmation from service 114 and the legacy account custodian.

In an embodiment, a thin transaction integration service 114 may solicit confirmation of transaction attributes, such as the amount of funds to be transferred, from one or more parties participating in a transaction before executing the transaction. Service 114 may also prompt the parties to provide other types of information required for completion of a transaction, as a matter of course or in response to a failed transaction. This feature of transaction processing may require novel types of information to be provided with the transaction data.

In an embodiment, a thin transaction integration service 114 may generate and/or maintain metadata regarding transactions and sell the data to interested parties and/or use the data to improve such aspects of transactions as security, reliability, data traffic routing, resource forecasting, etc.

In an embodiment, party-operated devices 120 include self-service terminals (SSTs), kiosks, point-of-sale (POS) terminals, automated teller machines (ATMs), smart phones, tablets, laptops, desktops, wearable processing devices, and/or voice-enabled network transaction devices (e.g., Google® Home®, Apple® Siri®, Amazon® Alexa®, etc.). In an embodiment, a merchant-operated server 130 includes a collection of servers for a given merchant that is operated as a cloud.

It is to be noted, that the thin integration transaction services 114 integrate with both legacy payment transfer services 143 and legacy account services 153. For example, the transactions can be between two non-business parties, such as two consumers who are transferring funds from one legacy account of a first consumer to a second legacy account of the second consumer. One or both of the consumers may or may not have alias accounts registered with cloud/server 110; regardless, service 114 interacts with the back-end interfaces of two legacy account services 153 to process the transaction on behalf of the consumers.

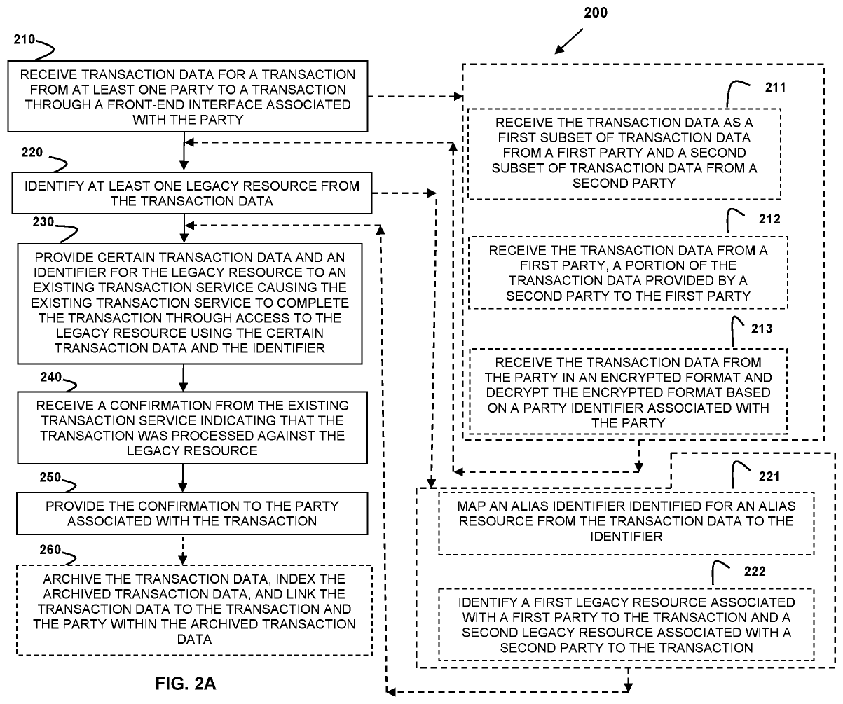

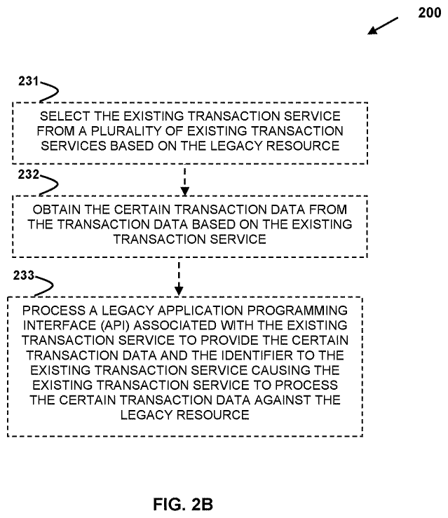

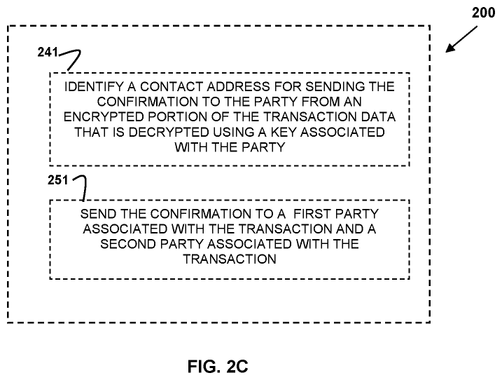

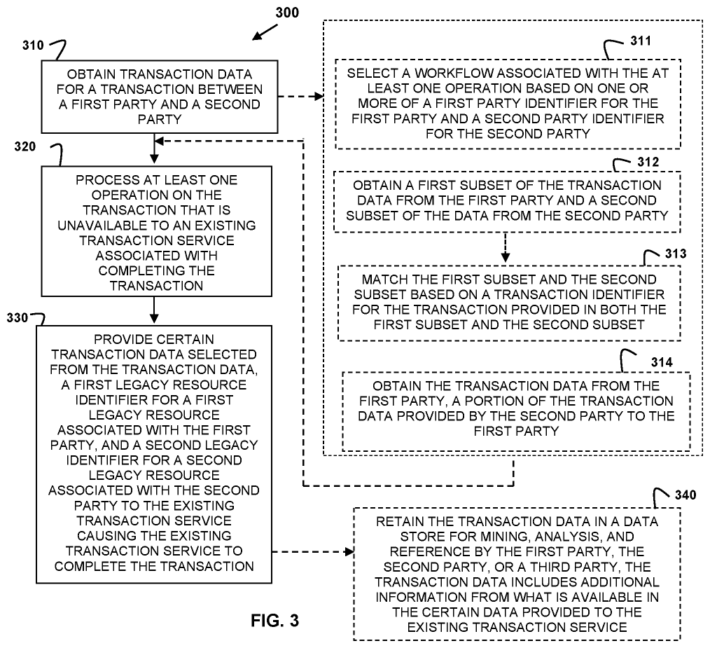

The above-discussed embodiments and other embodiments are now discussed with reference to FIGS. 2A-2C and 3. FIGS. 2A, 2B, and 2C are flow diagrams of a method 200 for providing and operating thin network transaction integration services. The software module(s) that implement(s) the method 300 is referred to as a “transaction integration service.” The transaction integration service is implemented as executable instructions programmed and residing within memory and/or a non-transitory computer-readable (processor-readable) storage medium and executed by one or more processors of a device or set of devices. The processor(s) of the device that executes the transaction integration service are specifically configured and programmed to process the transaction integration service The transaction integration service may have access to one or more network connections during its processing. The network connections can be wired, wireless, or a combination thereof.

In an embodiment, the device that executes the transaction integration service is cloud 110. In an embodiment, the device that executes the transaction integration service is server 110. In an embodiment, the transaction integration service is portal manager 113, services 114, and/or APIs 114.

At 210 (shown in FIG. 2A), the transaction integration service receives transaction data for a transaction from at least one party to a transaction through a front-end interface associated with the party. It is noted that a single party transaction can be processed when a user directly performs a gift or transfer to another party that is not in any way involved in the transaction. For example, most currency transfer apps allow funds to be transferred by one party to another party without the active engagement of the target party who is receiving the funds. It is also noted that access does not have to be only funds being transferred as the transaction can be related to any data access associated with medical data access, social media account access, service-based account access, etc. In an embodiment, transaction integration service may enable a party to transfer funds between accounts controlled by that party.

In an embodiment, at 211 (shown in FIG. 2A), the transaction integration service receives the transaction data as a first subset of transaction data from a first party to the transaction and a second subset of transaction data from a second party to the transaction. In this embodiment, there are two parties actively engaged in the transaction. In other embodiments there can be three or more parties engaged in the transaction.

In an embodiment, at 212 (shown in FIG. 2A), the transaction integration service receives the transaction data from a first party. A portion of the transaction data was provided to the first party by a second party. The portion provided from the second party to the first party can be encrypted, such that the first party is unable to decrypt the portion. Only the transaction integration service or a legacy account service is capable of decrypting the portion from the transaction data as was discussed above.

In an embodiment, at 213 (shown in FIG. 2A), the transaction integration service receives the transaction data from the party in an encrypted format. The transaction integration service decrypts the encrypted format based on a party identifier associated with the party or the parties that supplied the transaction data. The party identifier can be mapped to a public key associated with the encrypting party maintained by the transaction integration service. The transaction integration service can also use a private key of the transaction integration service to decrypt any encrypted portion or all of the transaction data.

At 220 (shown in FIG. 2A), the transaction integration service identifies at least one legacy resource from the transaction data. That is, the transaction may involve access to a single legacy resource to obtain information or may be related to access to multiple legacy resources.

In an embodiment, at 221 (shown in FIG. 2A), the transaction integration service maps an alias identifier that is identified from an alias resource from the transaction data to an identifier associated with the legacy resource. This is an embodiment, where the transaction integration service is enforcing aliased or virtualized resources overlaid on top of a legacy resource, such that the transaction data includes an alias identifier, which the transaction integration service maps to a legacy resource identifier.

In an embodiment, at 222 (shown in FIG. 2A), the transaction integration service identifies a first legacy resource associated with a first party to the transaction and a second legacy resource associated with a second party to the transaction. In this embodiment, there are two parties to the transaction and two legacy resource identifiers for the two legacy resources of the two parties.

At 230 (shown in FIG. 2A), the transaction integration service provides certain transaction data and an identifier for the legacy resource to an existing transaction service. This causes the existing transaction service to complete the transaction through access to the legacy resource using the certain transaction data and the identifier of the legacy resource.

In an embodiment, at 231 (shown in FIG. 2B), the transaction integration service selects the existing transaction service from a plurality of available existing transaction services based on the legacy resource. For example, a legacy resource for a checking account includes a routing number for the corresponding financial institution, which is mapped to a specific legacy account service 153. The legacy account service 153 is the selected existing transaction service.

In an embodiment of 231 and at 232 (shown in FIG. 2B), the transaction integration service obtains the certain transaction data from the transaction data based on the existing transaction service. For example and assuming there are two parties engaged in the transaction, an existing transaction service associated with a payment transfer service 143 or a transaction clearinghouse associated with processing credit card payments requires specific information about the credit card and information about the payee's bank account. The transaction integration service selects the certain transaction data based on the selected existing transaction service to obtain the specific information needed by the existing transaction service to complete the transaction on behalf of the parties.

In an embodiment of 232 and at 233 (shown in FIG. 2B), the transaction integration service processes a legacy API associated with the existing transaction service to provide the certain transaction data and the identifier for the legacy resource to the existing transaction service. This causes the existing transaction service to process the certain transaction data against the legacy resource or against two or more legacy resources as was discussed above.

At 240 (shown in FIG. 2A), the transaction integration service receives a confirmation from the existing transaction service. The confirmation provides an indication that the transaction was processed against the legacy resource. It is noted that when the existing transaction service is unable to complete the transaction a denial is received by the transaction integration service. If a denial is received, the transaction integration service informs the party or parties that the transaction failed.

In an embodiment, at 241 (shown in FIG. 2C), the transaction integration service identifies a contact address for sending the confirmation from an encrypted portion of the transaction data that is decrypted using a key associated with the party. In this manner, a party to a transaction can achieve increased security protection on their contact information by dynamically supplying that party's contact address in an encrypted format within the transaction data such that the contact address is never exposed in a text readable format over any network wire during the transaction. As discussed above, the party providing encrypted contact information can be a party that supplies a subset of the transaction data to the transaction integration service, or the party can provide the encrypted contact information to a second party and the second party provides all the transaction data (including the encrypted contact information of the first party) to the transaction integration service.

At 250 (shown in FIG. 2A), the transaction integration service provides the confirmation to the party or parties associated with the transaction. This can be a single party to the transaction or two or more parties to the transaction.

In an embodiment, at 251 (shown in FIG. 2C), the transaction integration service sends the confirmation to a first party associated with the transaction and also sends the confirmation to a second party associated with the transaction. This is a situation where there are at least two parties in the transaction. This is also different from a conventional transaction where only a payee receives confirmation for a completed transaction and the payer relies on the payee for confirmation.

In an embodiment, at 260 (shown in FIG. 2A), the transaction integration service archives the transaction data, indexes the archived transaction data, and links the transaction data to the transaction and the party or parties within the archived transaction data. That is, a data store that is searchable and minable for the transaction data is provided for access by the party, parties, or other third-parties not associated with the transaction. It is noted that different portions of the transaction data may be stored with different levels of security access. For example, a consumer's contact information may be incapable of being viewed by anyone other than the consumer. In fact, some portions of the transaction data may be encrypted within the data store such that only a key possessed by a particular party is capable of decrypting those portions.

FIG. 3 is a flow diagram of another method 300 for providing and operating thin network transaction integration services. The software module(s) that implement(s) the method 300 is referred to as a “transaction enhancement manager.” The transaction enhancement manager is implemented as executable instructions programmed and residing within memory and/or a non-transitory computer-readable (processor-readable) storage medium and executed by one or more processors of a device or set of devices. The processor(s) of the device that executes the transaction enhancement manager are specifically configured and programmed to process the transaction enhancement manager. The transaction enhancement manager may have access to one or more network connections during its processing. The network connections can be wired, wireless, or a combination thereof.

In an embodiment, the device the executes the transaction enhancement manager is cloud 110. In an embodiment, the device that executes the transaction enhancement manager is server 110.

In an embodiment, the transaction enhancement manager is all of, one of, or any combination of 113, 114, 115, 123, 134, and/or the method 200. The transaction enhancement manager presents another and, in some ways, an enhanced processing perspective from that which was described above with method 200.

At 310, the transaction enhancement manager obtains transaction data for a transaction between a first party and a second party. This is the situation where that transaction is being processed between two parties.

In an embodiment, at 311, the transaction enhancement manager selects a workflow associated with at least one operation based on one or more of a first party identifier for a first party and a second party identifier for a second party. That is, at least one party is registered with the transaction enhancement manager and has established customized rules, which the transaction enhancement manager uses to dynamically modify a workflow associated with processing the transaction.

In an embodiment, at 312, the transaction enhancement manager obtains a first subset of the transaction data from the first party and a second subset of the transaction from a second party. This is a situation where the transaction data is received in subsets from each of the parties such that the parties do not have to exchange any personal information between one another to process the transaction when the transaction enhancement manager is used for the transaction.

In an embodiment of 312 and at 313, the transaction enhancement manager matches the first subset and the second subset based on a transaction identifier or a unique token for the transaction. Each subset of transaction data includes a same or common transaction identifier or unique token.

In an embodiment, at 314, the transaction enhancement manager obtains the transaction data from the first portion. A portion of the transaction data is provided by the second party to the first party. It is noted that the first party can be the payer or the payee for the transaction.

At 320, the transaction enhancement manager processes at least one operation on the transaction that is unavailable to an existing transaction service associated with completing the transaction. That is features, functions, and capabilities of the transaction are extended and enhanced beyond that which the existing transaction service is capable of achieving.

At 330, the transaction enhancement manager provides certain transaction data selected from the transaction data, a first legacy resource identifier for a first legacy resource associated with the first party, and a second legacy resource identifier for a second legacy resource associated with the second party to the existing transaction service. This causes the existing transaction service to complete the transaction on behalf of the parties.

In an embodiment, at 340, the transaction enhancement manager retains the transaction data in a data store for mining, analysis, and reference by the first party, the second party, or a third party. The transaction data includes additional information beyond what is available in the certain data provided to the existing transaction service.

It should be appreciated that where software is described herein in a particular form (such as a component or module) this is merely to aid understanding and is not intended to limit how software that implements those functions may be architected or structured. For example, modules are illustrated as separate modules, but may be implemented as homogenous code, and/or as individual components. Some or all of these modules may be combined, or the functions may be implemented in software structured in any other suitable manner.

Furthermore, although the software modules are illustrated as executing on one piece of hardware, the software may be distributed over multiple processors or in any other suitable manner. The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving transaction data for a transaction from at least one party to a transaction through a front-end interface associated with the at least one party;
identifying at least one legacy resource from the transaction data;
providing certain transaction data and an identifier for the at least one legacy resource to an existing transaction service causing the existing transaction service to complete the transaction through access to the at least one legacy resource using the certain transaction data and the identifier;
receiving a confirmation from the existing transaction service indicating that the transaction was processed against the at least one legacy resource; and
providing the confirmation to the at least one party associated with the transaction.

2. The method of claim 1 further comprising, archiving the transaction data, indexing the archived transaction data, and linking the transaction data to the transaction and the at least one party within the archived transaction data.

3. The method of claim 1, wherein receiving the transaction data further includes receiving the transaction data as a first subset of transaction data from a first party and a second subset of the transaction data from a second party.

4. The method of claim 1, wherein receiving the transaction data further includes receiving the transaction data from a first party and a portion of the transaction data is provided by a second party to the first party.

5. The method of claim 1, wherein receiving the transaction data further includes receiving the transaction data from the at least one party in an encrypted format and decrypting the encrypted format based on at least one party identifier associated with the at least one party.

6. The method of claim 1, wherein identifying further includes mapping an alias identifier identified for an alias resource from the transaction data to the identifier.

7. The method of claim 1, wherein identifying further includes identifying the at least one legacy resource as a first legacy resource associated with a first party to the transaction and a second legacy resource associated with a second party to the transaction.

8. The method of claim 1, providing the certain transaction data further includes selecting the existing transaction service from a plurality of existing transaction services based on the at least one legacy resource.

9. The method of claim 8, wherein selecting further includes identifying the certain transaction data from the transaction data based on the existing transaction service.

10. The method of claim 9, wherein selecting further includes processing a legacy application programming interface (API) associated with the existing transaction service to provide the certain transaction data and the identifier for the transaction to the existing transaction service causing the existing transaction service to process the certain transaction data against the at least one legacy resource.

11. The method of claim 1, wherein providing the confirmation further includes identifying a contact address for sending the confirmation to the at least one party from an encrypted portion of the transaction data that is decrypted using a key associated with the at least one party.

12. The method of claim 1, wherein providing the confirmation further includes sending the confirmation to a first party associated with the transaction and a second party associated with the transaction, wherein the at least one party includes the first party and the second party.

13. A method, comprising:
obtaining transaction data for a transaction between a first party and a second party;
processing at least one operation on the transaction that is unavailable to an existing transaction service associated with completing the transaction; and
providing certain transaction data selected from the transaction data, a first legacy resource identifier for a first legacy resource associated with the first party, and a second legacy resource identifier for a second legacy resource associated with the second party to the existing transaction service causing the existing transaction service to complete the transaction.

14. The method of claim 13, wherein obtaining further includes selecting a workflow associated with the at least one operation based on one or more of a first party identifier for the first party and a second party identifier for the second party.

15. The method of claim 13, wherein obtaining further includes obtaining a first subset of the transaction data from the first party and a second subset of the transaction data from the second party.

16. The method of claim 15, wherein obtaining further includes matching the first subset and the second subset of the transaction data based on a transaction identifier for the transaction provided in both the first subset and the second subset of the transaction data.

17. The method of claim 13, wherein obtaining further includes obtaining the transaction data from the first party and a portion of the transaction data is provided by the second party to the first party.

18. The method of claim 13 further comprising:
retaining the transaction data in a data store for mining, analysis, and reference by the first party, the second party, or a third party, wherein the transaction data includes more data than what is available in the certain data provided to the existing transaction service.

19. A system, comprising:
a server comprising at least one processor and a non-transitory computer-readable storage medium;
the non-transitory computer-readable storage medium comprising server executable instructions;
the server executable instructions, when executed by the at least one processor, cause the at least one processor to perform operations comprising:
receiving transaction data for a transaction between a first party and a second party;
mapping one or more alias resource identifiers for alias resources identified in the transaction data to one or more legacy resource identifiers for legacy resources;
processing at least one operation on the transaction that is unavailable to an existing transaction service associated with completing the transaction;
updating ledgers associated with the one or more alias resources based on details defined in the transaction data; and
sending certain transaction data selected from the transaction data and the one or more legacy resource identifiers to the existing transaction service causing the existing transaction service to complete the transaction against the one or more legacy resources.

20. The system of claim 19, wherein the operations further comprise:
receiving a confirmation from the existing transaction service indicating that the existing transaction service completed the transaction; and
sending the confirmation to both the first party and the second party based on selective portions of the transaction data.
